(19) United States
(12) Patent Application Publication
(10) Pub. No.: US 2002/0086657 A1
(43) Pub. Date: Jul. 4, 2002

(54) Telecommunications device, system comprising such a device and telecommunications method

(76) Inventor: Jean Alain Chabas, Cesson-Sevigne (FR)

Correspondence Address: Corporate Patent Counsel, U.S. Philips Corporation, 580 White Plains Road, Tarrytown, NY, 10591, US

(21) Appl. No.: 10/028,120

(22) Filed: Dec. 21, 2001

(30) Foreign Application Priority Data
Dec. 28, 2000 (FR) 0017201

(51) Int. Cl. H04Q 7/20

(52) U.S. Cl. 455/403; 455/424

(57) ABSTRACT

This telecommunications device (21, 22 or 23) forms part of a system comprising base stations (10, 12). This system permits the devices forming it to relay information among them. It is proposed to provide the devices with a plurality of transceiver devices (RX1, RX2, . . . , RXm, TX1, TX2, . . . , TXn) for exchanging information with other devices and/or base stations. Application: ODMA mobile radios

The invention relates to a telecommunications device for a system comprising at least a base station and a plurality of secondary stations including circuits for relaying the information among them.

The invention also relates to a transmission system comprising at least such device.

The invention further relates to a transmission method implemented in such a system.

The invention finds applications when the transmission technique known by the name of “ODMA” is used. This technique proposes to use all the stations of the system as information relays. Thus if a station does not manage to be connected to a base station, it can nevertheless be connected by utilizing other mobile stations as relays. In the publication “WCDMA for UMTS” by Harri Holma and Antti Toskala, edited by Wiley, information about this ODMA technique will be found.

The present invention proposes a device of the type defined in the opening paragraph which has largely enhanced performance.

For this purpose, such a device is characterized in that the secondary stations comprise a plurality of transceiver devices for exchanging information with other stations (base and/or secondary).

The inventive idea thus comprises the use of the teaching given by the architecture known by the name of “MIMO” which proposes to multiply the number of transceiver devices for each secondary station. The idea also comprises to benefit from the system to further improve the MIMO technique by adding transmission paths, by varying the diversity even more. This architecture is described in articles such as, for example: “Capacity results on frequency-selective Rayleigh MIMO channels” by Daniel Pérez et al., published in the Conf. IST-Ireland in October 2000 on pp. 491 to 496.

These and other aspects of the invention are apparent from and will be elucidated, by way of non-limitative example, with reference to the embodiment(s) described hereinafter.

In the drawings:

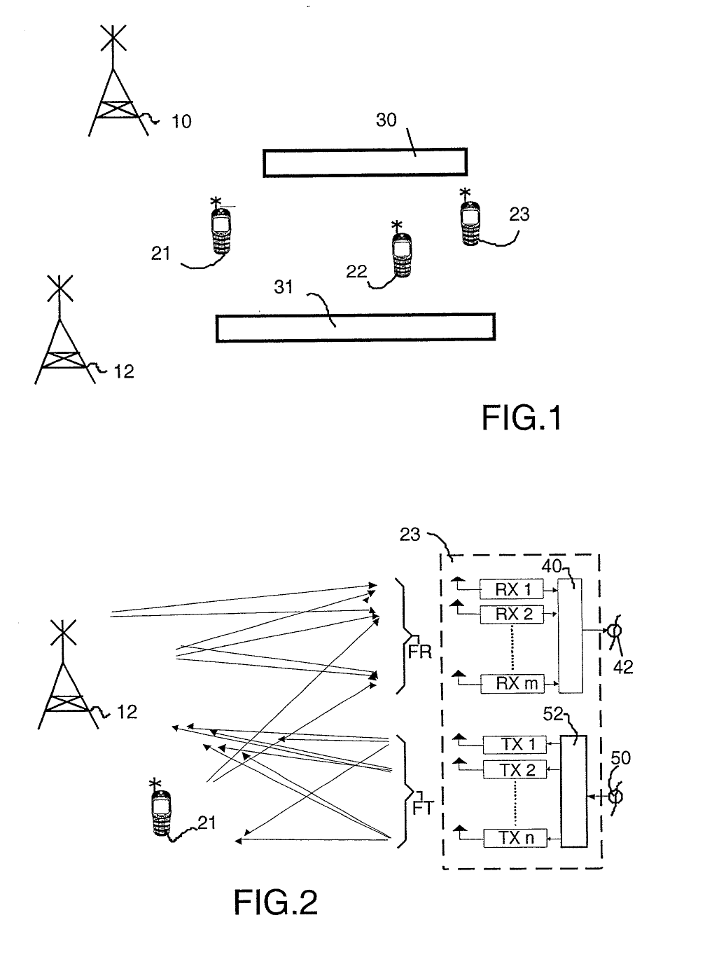

FIG. 1 shows a system comprising at least a device according to the invention,

FIG. 2 shows in more detail the structure of a device according to the invention.

FIG. 1 shows a cellular system in which the ODMA technique is implemented. The system comprises two base stations 10 and 12 and a plurality of secondary stations 21, 22, 23, which are telecommunications devices forming the object of the invention. The rectangles referred to as 30 and 31 are obstacles to the transmission, for example, buildings. If the secondary station 21 can communicate with the base stations 10 and 12, the secondary stations 22 and 23 cannot. Thus the station 22 can at most communicate with the base station 12 but not at all with the station 10, whereas the station 23 is incapable of communicating with these two base stations 10 and 12. For the latter secondary station to be able to communicate nevertheless, the ODMA technique proposes that the secondary stations can relay the communications. In the example described the station 23 can communicate thanks to a relay by the station 21. It will be obvious that these two secondary stations are close together for this purpose.

FIG. 2 shows in more detail the structure of the secondary station. According to the invention the secondary station 23 is in essence constituted by a plurality of receiving devices RX1 to RXm and a plurality of transmitting devices TX1 to TXn. The various receiving devices RX1 to RXm supply their information to a processing circuit 40 to establish useful information at a receiving access 42 to be used. In a similar manner, useful information to be transmitted, available on a transmit access 50 is distributed by means of a transmission processing circuit 52 to various transmitting devices TX1 to TXn. The number of transmission devices may be equal to the number of receiving devices (m=n). This secondary station thus has a structure of a type known by the name of MIMO cited above. These transmitting devices and these receiving devices may have radio traffic with the sole station 21. But it is also possible that a certain number of these transmitting devices have radio traffic with the base station, whereas the others have radio traffic with the secondary station 21. This is shown in the Figure by arrows FT and FR, which indicate the transmission and reception, respectively, for the station 23. It will be recalled that the function of relay or repeater effected by the station 21 permits a better processing, for the diversity is ensured in this case at the level of the station 23.

By the invention:

the concept of the MIMO architecture is extended to the repeater mode of the operation in a cellular network and in a more particular manner for the ODMA mode and for FDD (Frequency Division Diversity),

a contribution is made towards further reduction of the noise level in the small cells for which the ODMA mode is implemented and as a result of which the quality of the services offered by the network and the capacity of traffic of the cell is improved,

a contribution is also made towards improving the transition process between these modes. There is a parallel processing of the transmitted data, which permits to go to the TDD mode (Time Division Diversity) as this is done in the FDD mode.

1. A telecommunications device for a system comprising at least a base station and a plurality of secondary stations including circuits for relaying information, characterized in that the secondary stations comprise a plurality of transceiver devices for exchanging information with other stations (base stations and/or secondary stations).

2. A telecommunications device as claimed in claim 1, characterized in that the system is an ODMA system.

3. A telecommunications device as claimed in claim 1 or 2 characterized in that the plurality of transceiver devices are MIMO-type.

4. A telecommunications system comprising at least a base station and a plurality of secondary stations as claimed in claim 1, 2 or 3, including circuits for relaying information, characterized in that the secondary stations comprise a plurality of transceiver devices for exchanging information with other stations (base stations and/or secondary stations).

5. A telecommunications system as claimed in claim 4, characterized in that it is an ODMA system.

6. A transmission method for a telecommunications system comprising at least a base station and a plurality of secondary stations as claimed in claim 1, 2 or 3, including circuits for relaying information, characterized in that, for ensuring a transmission, it comprises a step according to which the secondary stations carry out space-diversity transmission and also space-diversity reception.
